(19) United States
(12) Patent Application Publication
(10) Pub. No.: US 2006/0260488 A1
(43) Pub. Date: Nov. 23, 2006

(54) INK PROOFER CLEANING SYSTEM

(76) Inventor: Ronald K. Westby, Ramsey, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/382,623

(22) Filed: May 10, 2006

Related U.S. Application Data
(60) Provisional application No. 60/679,918, filed on May 10, 2005.

(51) Int. Cl. B41F 35/00

(52) U.S. Cl. 101/424

(57) ABSTRACT

An apparatus and method for cleaning an ink proofing head. The apparatus includes a continuous moving surface that engages a rotatable member of the ink proofing head, such as the anilox roller or the transfer roller, causing at least one of the members to rotate. A cleaning fluid is supplied to wet and cleanse the continuous moving surface and the inked surfaces of the ink proofing head. The fluid may be applied by immersing a portion of the continuous moving surface in a bath, or by pumping the fluid directly on to the ink proofing head. The ink-laden cleaning fluid may be conveyed to a decantation tank, enabling the ink to settle and the cleaning fluid to subsequently be re-used. A drag force may be applied to one or more of the rotating members of the ink proofing head, causing the rotating members to slip relative to the continuous moving surface and inducing a scrubbing action.

### CLAIM TO PRIORITY

This application claims priority to U.S. Provisional Application 60/679,918, filed May 10, 2005, entitled “Ink Proofer Cleaning System,” the contents of which are hereby incorporated by reference in their entirety.

### FIELD OF THE INVENTION

The present invention relates generally to the fields of flexographic, gravure, and offset printing, and more particularly, to a portable flexographic ink proofing apparatus for providing proofs of ink samples for purposes of color and density correction and press correlation to mimic printing properties. More particularly, the present invention relates to a cleaning system for cleaning an ink proofer.

### BACKGROUND OF THE INVENTION

An ink proofer is utilized in the field of flexographic printing to predict the color of an ink composition prior to a production run. Typically, the specimens or “proofs” produced by an ink proofer are analyzed by computer microscopy to obtain color matching data and to provide customers with samples of what the ink colors would look like on a particular desired substrate during a production run, without incurring the monetary and time costs attendant the use of actual production equipment. The proofs can be used to test for color, gloss, opacity, penetration or wicking into the substrate and drying time, as well as determination of the rub and abrasion resistance of the ink.

The proofs are obtained by drawing ink over an appropriate substrate. Application of the ink to the substrate is typically performed using a manual ink proofer tool or an ink proofer machine of the type manufactured by Harper Companies International of Charlotte, N.C. Both types of ink proofers typically comprise an ink proofing head having a pair of spaced arms holding a doctor blade, an anilox roller and a transfer roller. The ink proofing head is typically small enough to be held in one's hands. (Hereinafter, a “hand held” ink proofing head is one that is capable of being transferred by hand, whether used in a manual or a machine driven ink proofer.) Manual units are equipped with a handle operably attached to the ink proofing head. The ink may be applied by rolling the ink proofer through an ink bath or saturated sponge, or by a cartridge that feeds ink onto the ink proofer rollers as the rollers are rotated. An ink proofer machine includes an apparatus for rotationally driving the rollers of the ink proofing head, in combination with a means for feeding a substrate material. Ink proofer machines often accommodate manual ink proofer tools for the proofing head.

A traditional concern with the aforementioned proofing process is the proper simulation of the lithographic process. Factors such as application pressure, roller speed and resiliency, and frictional characteristics of the substrate all have an effect on the quality of the proof. Unless these factors are reasonably simulated in the proofing process, the sample will not have the same characteristics as the mass produced counterpart. Advances in the art of ink proofing include the introduction of the “PERFECT PROOFER,” an ink proofing machine recently developed by Integrity Engineering of Ramsey, Minn., assignee of the present invention. The “PERFECT PROOFER” is disclosed in U.S. Provisional Patent Application No. 60/671,489 which is hereby incorporated by reference. The “PERFECT PROOFER” feeds substrate material at a selected speed and applies the roller to the substrate at a specified application pressure, thereby enabling a technician to compensate for variations in the resiliency of both the drive roller and the transfer roller of the hand held proofer under use. This arrangement enhances the repeatability and the correlation between the characteristics of the proof and the production printing.

The improved repeatability of ink proofing machines created by use of the “PERFECT PROOFER” has brought other aspects of the ink proofing process to the forefront in terms of further improving ink proofs. In particular, the cleanliness of the hand held proofer unit, and in particular the doctor blade, anilox roller and transfer roller, heretofore considered important but secondary in nature, is now a primary factor in the repeatability and representation of an ink proof. The cleanliness of the anilox roller, with its etched cells on the surface for holding and transferring ink, is of particular importance. Ink and other contaminants that may become dried or lodged in the cells, not only affecting the color of subsequent smears, but also preventing the anilox roller from holding and depositing the expected amount and pattern of ink, which also affects the color of the proof.

Currently, an ink proofer is cleaned by carrying the hand held unit to a wash bath of a cleaning solution or solvent, disassembling the unit therein, and soaking the components for a predetermined amount of time to permit the dried ink or contaminants to soften and/or dissolve. After letting the ink proofer soak, a towel or similar device is used to wipe the ink proofer components clean, and the unit is reassembled. Often, in order to achieve the desired level of cleanliness, the hand held unit of an ink proofing system is disassembled, with the anilox roller and transfer roller being dislodged from the framework of the hand held unit. In addition to being labor intensive and inefficient, there is a risk that the components will collide with each other and become damaged during washing and reassembly. Moreover, the ink proofer cannot be used while it is soaking or being wiped clean, often requiring expenditure of additional revenue to purchase multiple ink proofers (each costing several thousands of dollars) to account for the downtime associated with each ink proofer being cleaned. The manual wipe down of the ink proofer further increases a company's labor expenditure, and increases the risk of damaging or degrading the cells on the anilox roller (each costing several hundreds of dollars).

The cleaning process must also ensure that the ink proofer is dry and does not contain any residual fluid. Residual fluid can mix with the new ink sample and affect the proof obtained with the ink, rendering the proof useless in predicting the ink color in a press production run. Further, the cleaning system for the ink proofer must be reasonably uncomplicated and not overly burdensome. A difficult or time-consuming process may result in short-cuts or oversights with negative results.

There is a need in the ink press industry for an ink proofer cleaning system that reliably, efficiently, and inexpensively cleans an ink proofer, and in a way that minimizes the risk of damaging to the anilox roller. The need exists for both manual and machine operated ink proofers or ink proofer cartridges. An approach that addresses the aforementioned requirements, as well as other related requirements, is therefore desirable.

### SUMMARY OF THE INVENTION

The ink proofer cleaning apparatus of the present invention substantially meets the aforementioned needs of the industry. In one embodiment of the invention, an ink proofer cleaning apparatus provides for cleaning an ink proofing head. The head is affixed to an ink proofer cleaning apparatus. The transfer roller of the proofing head is in contact with a scrubber roller of the cleaning apparatus. The scrubber roller is at least partially wetted by cleaning fluid and is rotated by a motor. The scrubber roller transfers cleaning fluid to the transfer roller, which in turn draws cleaning fluid to the anilox roller. The anilox roller draws cleaning fluid to the doctor blade. The cleaning fluid covers the various rollers and enters the nips between the rollers.

In another embodiment of the invention, a fluid line delivers cleaning fluid in the vicinity of the doctor blade. The cleaning fluid then flows on to the anilox roller, transfer roller and scrubber roller. The cleaning apparatus is pneumatically powered to rotate the scrubber roller, initiate contact between the scrubber roller and the ink proofing head, and pump the fluid through the nozzle, so that the cleaning process is substantially automatic.

In another embodiment of the invention, the ink proofer cleaning apparatus described above is adapted to be used with a manually operated ink proofer. A universal proofer holder is used to hold the ink proofing head or cartridge. Once the manual ink proofer is attached to the universal proofer holder, the cleaning process is substantially the same as the process of cleaning the ink proofer cartridge.

According to another aspect of the invention, the ink proofer cleaning apparatus provides a series of trays containing cleaning and rinsing fluids such that a manual ink proofer can be cleaned and dried to meet the performance requirements of the industry.

Preferably, after the ink proofing head or cartridge is cleaned, it is exposed to a stream of pressurized air to complete the cleaning process by removing any remaining cleaning fluid and expedite drying of the anilox roller. Cleaning fluid remaining on the hand ink proofer or the ink proofer cartridge may effect the performance of the ink proofer, and hence, the proofs produced by the proofer.

### BRIEF DESCRIPTION OF THE DRAWINGS

FIG. 1 is a perspective view of an embodiment of an ink proofer cleaning apparatus.

FIG. 2 is a cut away elevation view of an ink proofer cleaning apparatus.

FIG. 3 is a cut away elevation view of an ink proofer cleaning apparatus.

FIG. 4 depicts an ink proofing head in contact with a drum roller.

FIG. 5 is a side view of a universal proofer holder with a detachable ink proofing head mounted thereon.

FIG. 6 is a front view of an embodiment of an ink proofer cleaning apparatus.

FIG. 7 is a side view of the ink proofer cleaning apparatus of FIG. 6

FIG. 8 is a perspective view of a cover plate.

FIG. 9 is a cut away elevation view of an ink proofer cleaning apparatus.

FIG. 10 is a plan view of the ink proofer cleaning apparatus of FIG. 9.

FIG. 11 is a cut away elevation view of the ink proofer cleaning apparatus of FIG. 9.

FIG. 12 is a perspective view of the universal proofer holder.

FIG. 13 is a perspective view of the universal proofer holder shown in FIG. 12 with an ink proofing head mounted therein.

FIG. 14 is a side view of a tray ink proofer cleaning apparatus.

FIG. 15 is a front perspective view of an ink proofer cleaning apparatus.

FIG. 16 is a cut away elevation view of an ink proofer cleaning apparatus.

FIG. 17 depicts an ink proofer cleaning apparatus with remote decantation tank.

FIG. 18 illustrates the fluid flow over an anilox roller.

FIG. 19 is a front perspective view of an ink proofer cleaning apparatus.

### DETAILED DESCRIPTION OF THE DRAWINGS

The invention is generally directed to an ink proofer cleaning system that is adapted to be used with a variety of ink proofer devices, including the devices discussed in U.S. Pat. No. 6,814,001 and pending U.S. application Ser. No. 10/976,194 both of which are incorporated herein by reference in their entirety. In one embodiment, the ink proofer cleaning system is designed to clean a hand or manually operated ink proofer. The ink proofer may comprise a handle, a frame having pair of spaced arms holding a doctor blade, an anilox roller, and a transfer roller. A variety of different types and brands of ink proofers can be cleaned using the ink proofer cleaning system of the present invention.

In another embodiment, the ink proofer cleaning system is adapted to clean an ink proofer cartridge or proofing head that is part of an ink proofer arrangement or apparatus. The ink proofing head includes an anilox roller and a transfer roller operably disposed in a housing, and may also include a doctor blade. Typically, an ink proofing head does not include a handle, but optionally may have a handle attached to one end.

Referring to the Figures, an ink proofer cleaning apparatus 100 according to the present invention is depicted. The ink proofer cleaning apparatus 100 includes a base unit 102 that supports an ink proofer cartridge or proofing head 101. The base unit 102 includes a control panel 104. A housing 103 is designed to be spill proof, enabling the ink proofer cleaning apparatus 100 to be washed down easily without damage to internal components. A number of control switches and displays are mounted on the control panel 104 of housing 103. A rubber cylindrical drum roller 106 protrudes from the upper surface of housing 103.

The ink proofer cartridge 101 is supported on an ink proofer cartridge support 140, an angled support that pivotally affixed to the top of base unit 102 for supporting ink proofer cartridge 101 at a predetermined angle. The cartridge support 140 is movable in a generally vertical direction. The ink proofer cartridge 101 is brought into contact with the scrubber 106 when the cartridge support 140 is positioned vertically up and away from coarse grind rubber scrubber roller 106 or vertically down and in contact with coarse grind rubber scrubber roller 106. Cartridge support 140 includes a vertical fixed support bracket 142 that is coupled to a proofer cartridge support plate 144 that is in turn coupled to a proofer cartridge movement mechanism 146 which moves vertically up and down through the surface of the base unit 102 thereby moving ink proofer cartridge 101 as desired. Ink proofer cartridge 101 is secured to support 140 via a proofer cartridge secure plate 148 and a fastener 152 such as a screw or similar device.

The rubber cylindrical drum roller 106 cleans the ink proofer cartridge 101. The combination of the base unit 102 and the ink proofer cartridge 101 facilitates automatic cleaning the ink proofer cartridge 101, and can be adapted for cleaning hand ink proofer tools with some adjustment (described later). Moreover, the ink proofer cleaning apparatus 100 of the present invention is not limited to ink proofer tools of the type disclosed herein.

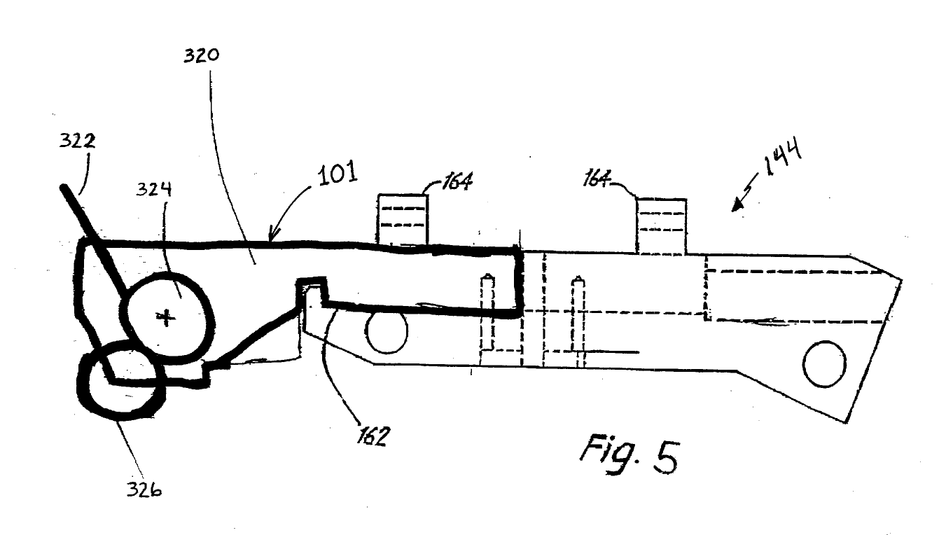

FIG. 5 illustrates a side view of an example embodiment of the ink proofer cartridge 101 that is mountable on an embodiment of the ink proofer cleaning apparatus 100. In particular, cartridge 101 includes a base frame 320, an anilox roller 324, a transfer roller 326, and a doctor blade 322. The ink proofer cartridge 101 is mounted on the proofer cartridge support plate 144, such that the cartridge fits over notch 162.

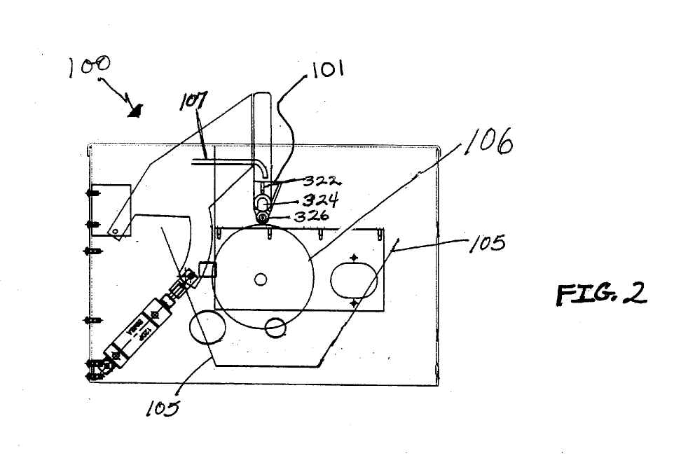

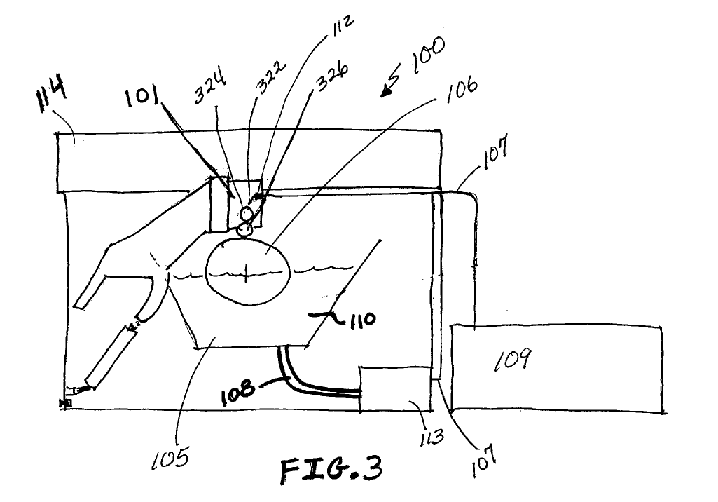

Referring to FIGS. 2 and 3, there are depicted views of the ink proofer cartridge cleaning apparatus 100, wherein fluid tank 105 is inside housing 103. Fluid tank 105 is filled with a cleaning solution 110 that is utilized primarily to remove ink from the surfaces of the ink proofer cartridge transfer roller 326, anilox roller 324 and doctor blade 322. In addition to cleaning fluid in tank 105, a fluid line 107 may act as a conduit for the transportation of the cleaning solution 110 from tank 105, or alternatively, from exteriorly located cleaning fluid tank 109, to doctor blade 322.

In one embodiment, fluid line 107 optionally has flood nozzle 112 removably coupled on the end of fluid line 107. The flood nozzle 112 directly deposits the cleaning fluid or solution 110 on doctor blade 322. The flood nozzle 112 may include any type of nozzle compatible with the cleaning solution 110 and capable of producing a pressurized flow.

In an example embodiment, a motor (not shown) that rotates scrubber roller 106 also runs or powers pump 113, such that the cleaning fluid 110 is pumped from either exteriorly located cleaning fluid tank 109 or fluid tank 105 disposed in housing 103 through fluid line 107 to doctor blade 322. The cleaning fluid 110 then flows from doctor blade 322, over and generally around anilox roller 324 and over and around transfer roller 326, finally being deposited into fluid tank 105. As is readily notable, in embodiments having an internal fluid tank 105, the cleaning solution 110 is re-circulated through a return line 108. In another example embodiment, internal fluid tank 105 and external fluid tank 109 may be used simultaneously.

As illustrated in FIG. 3, drum roller 106 is rotatably disposed in the internal fluid tank 105 and driven by a motor (not shown). The drum roller 106 may be motor driven, and may be comprised of a smooth rubber, a coarse grind scrubbing rubber, or a cylindrical scrub brush. Other types drum rollers may be utilized, as well as an endless or continuous surface, such as a scrubbing belt.

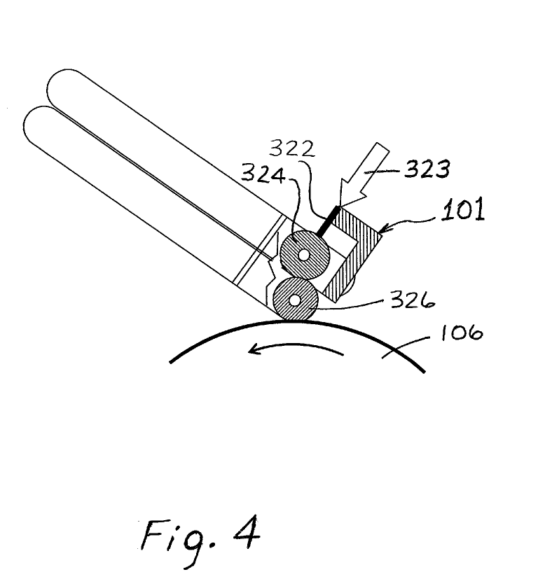

Operationally, the rotation of the drum roller 106 will drive the transfer roller 326 which in turn drives the anilox roller 324. Generally, there will be no significant slippage between the drum roller 106 and the transfer roller 326, in which case the drum roller 106 having a smooth rubber surface is preferred. Slippage between the drum roller 106 and the transfer roller 326 may be imposed by applying a resistance to the rotating members of the ink proofer. For example, referring to FIG. 4, applying a force 323 to the doctor blade 322 causes a resistance to the rotation of the on the anilox roller 324 and the transfer roller 326. An adequate resistance will cause slippage and a scrubbing action between the drum roller 106 and the transfer roller 326, for which a coarse grind scrubbing rubber or a cylindrical brush is particularly appropriate. Other means may also be employed to impose resistance to the rotating members 324, 326 of the ink proofing head.

The scrubber roller 106 transfers the cleaning fluid 110 to and scrubs or cleans the transfer roller 326. The transfer roller 326 then transfers cleaning fluid to the anilox roller 324, which in turn transfers the cleaning fluid to doctor blade 322. Hence, the cleaning fluid circulates as follows: it flows from internal fluid tank 105 to scrubber roller 106, which transfers it to transfer roller 326, which in turn transfers it to the anilox roller 324. The cleaning fluid is then transferred to doctor blade 322, back to anilox roller 324, transfer roller 326, scrubber roller 106 and finally into fluid tank 105.

In another example embodiment of the invention, internal fluid tank 105 and potentially scrubber roller 106 are positionable behind a drum roller of an ink proofer cleaning apparatus that is used to advance a moving substrate beneath the ink proofer. In this example embodiment, the ink proofer or ink proofer cartridge cleaning apparatus 100 is disposed adjacent to the ink proofing operation. The close proximity of the ink proofer cleaning apparatus 100 and the ink proofing operation shortens equipment downtime while permitting more frequent cleanings.

In this example embodiment, the ink proofer or cartridge may be adjusted such that it may be placed in or adjacent to the ink proofer cleaning apparatus 100. The cleaning of the ink proofer or cartridge may be accomplished as described above. Once the cleaning is completed the ink proofer or cartridge is repositioned above the cylindrical drum roller and ink proofing may be resumed.

In another example embodiment, the ink proofer cleaning apparatus 100 is designed such that housing 103 can hold water or cleaning solvent in the cabinet of the housing. A separate tank to hold cleaning fluid is not required.

Optionally, ink proofer cleaning apparatus 100 can have cover or lid 114 that fits over the entire unit. Any cleaning fluid that may splash from the fluid line 107, flood nozzle 112 or rollers, is maintained in the closed container. If the cleaning fluid is at all harsh or emits any fumes or odors, the technician cleaning the ink proofer cartridge 101 is not as exposed as if there were no cover 114. After ink proofer cartridge 101 is cleaned, it may be exposed to a stream of pressurized air, to thoroughly dry the various components of the ink proofer cartridge 101.

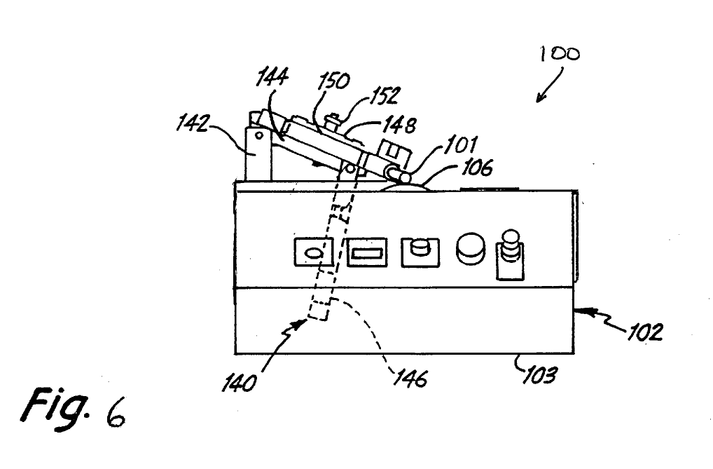

Referring now to FIGS. 6 and 7, another embodiment of the proofer cartridge cleaning apparatus 100 of the present invention is shown. Base unit 102 includes main housing 103 in which rubber covered cylindrical drum roller 106 is mounted that is driven by a drive motor (not shown) within base unit 102. In an embodiment thereof, the drum roller 106 includes a coarse grind rubber scrubber roller.

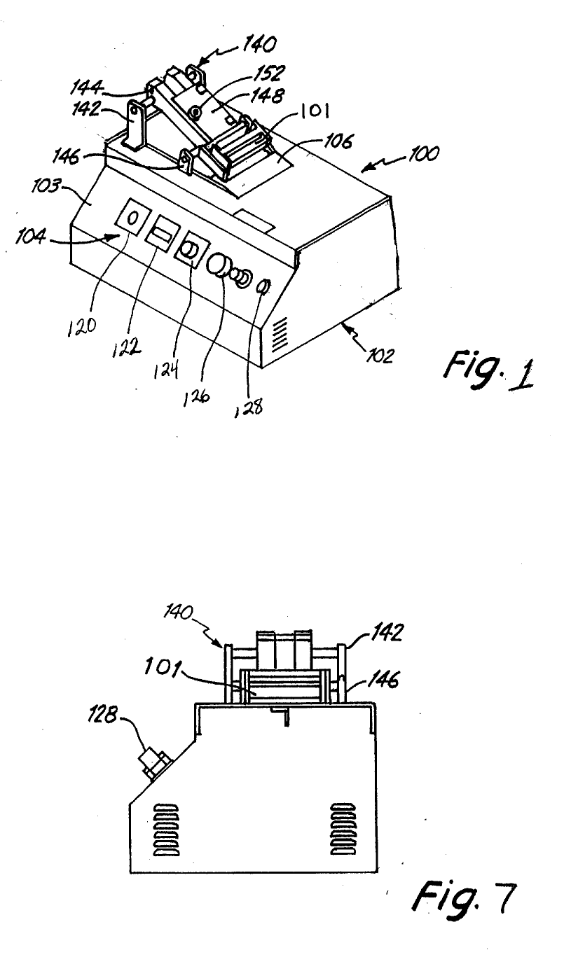

The control panel 104 of the FIG. 1 embodiment includes an on/off switch 120 which can be substituted with a push button so as to control the proofer cartridge 101 manually. Pressure gauge 126 is also included which provides feedback to the user when using the air regulator 128 to control the pressure of the roller 106 against the rollers of the ink proofer cartridge 101.

Referring to FIG. 6, in this example embodiment proofer cleaning apparatus 100 is configured to lift ink proofer cartridge 101 above scrubber roller 106 to provide the additional feature of keeping the scrubber roller 106 clean until the proofer cartridge 101 is ready for cleaning and is then placed in contact with the scrubber roller 106. Referring to FIG. 7, there is illustrated a side view of proofer cleaning apparatus 100 with the ink proofer cartridge 101 resting on the surface of roller 106. Ink proofer cartridge 101 is also resting on ink proofer cartridge support 140 located over base unit 102.

Referring to FIG. 5, there is illustrated ink proofer cartridge 101 that is set within a universal proofer holder 144 according to the present invention. The ink proofer cartridge 101 is held within holder 144 via a notch 162.

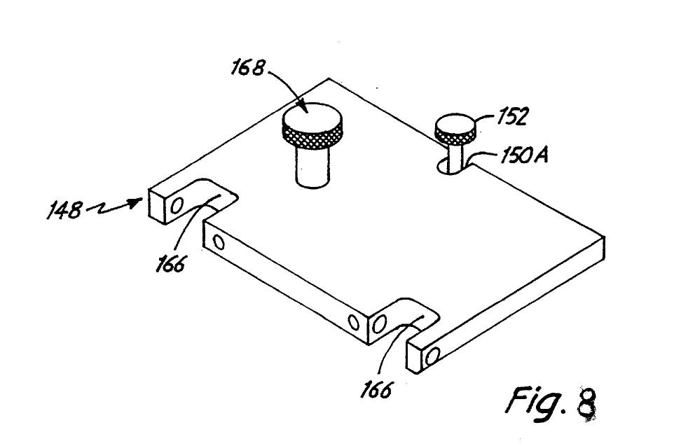

As depicted in FIG. 5, universal holder 144 further includes hinge barrels 164 that engage cover plate 148 (depicted in FIG. 8) that maintains the ink proofer cartridge 101 in the universal holder 144. Holder 144 further includes aperture 150 for accommodating fastener 152, such as a screw, that maintains cover plate 148 over universal holder 144.

Turning now to FIG. 8, cover plate 148 is depicted that includes hinge apertures 166 that engage hinges 164 of the universal holder 144. Cover plate 148 further includes an aperture 150a that corresponds with aperture 150 on universal holder 144 for accommodating fastener 152.

Proofer cleaning apparatus 100 is also configured to be self-equalizing thereby providing a wrist action to allow the rolls on the ink proofer cartridge 101 and scrubber roller 106 to conform to any movement of wobble during the ink proofer cartridge 101 cleaning process. By using a pneumatic drive mechanism, the concerns that ink technicians have that utilize solvents with low flash points may be alleviated when using the present invention. Proofer cleaning apparatus 100 also includes a down pressure gauge to determine how many pounds of pressure are being applied with the ink proofer tool.

In this example embodiment, the drive motor is preferably of the air type (½ horsepower) but ink proofer cleaning apparatus 100 can also be configured to operate with a clutch drive and clutch brake assembly. In other embodiments, the drive motor can include a DC motor, an electric motor or an AC motor.

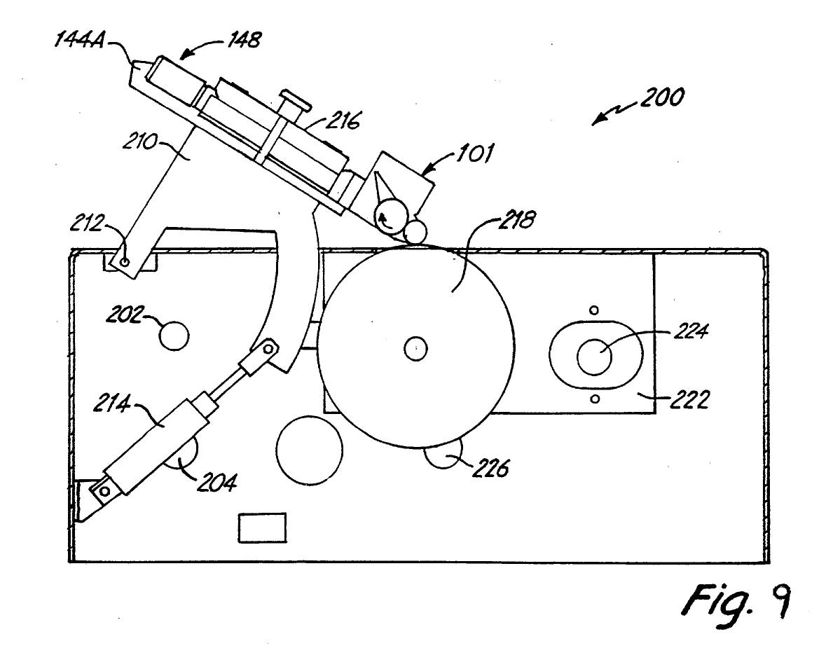

FIGS. 9-11 depict another example embodiment of ink proofer cleaning apparatus 200 that is configured to automatically lift ink proofer cartridge 101 (default position) above scrubbing roller 218 when start button 226 is disengaged. Proofer cleaning apparatus 200 includes pressure gauge 202, and may also include a pressure adjuster 204 for adjustment of the engagement pressure of the proofer cartridge 101 on the scrubbing roller 218. Unibody frame 210 accommodates universal holder 144 and ink proofer cartridge 101 is attached to pivot point 212 of apparatus 200. The other end of unibody frame 210 is attached to an actuation/pressure cylinder 214, which operates to move unibody frame 210 generally vertically, thereby moving the proofer cartridge 101 down when proofer cleaning apparatus 200 is actuated by start button 226. Proofer cleaning apparatus 200 further includes a proofer cartridge support assembly that includes universal holder 144, a cover plate 148 and ink proofer cartridge 101. In one embodiment, scrubbing roller 218 is driven by a belt and pulley drive 220 (via a cog belt) that is further driven by an air motor 222 located adjacent the coated roller. The speed of motor 222 is controlled by air motor speed control 224 via the exhaust of motor 222.

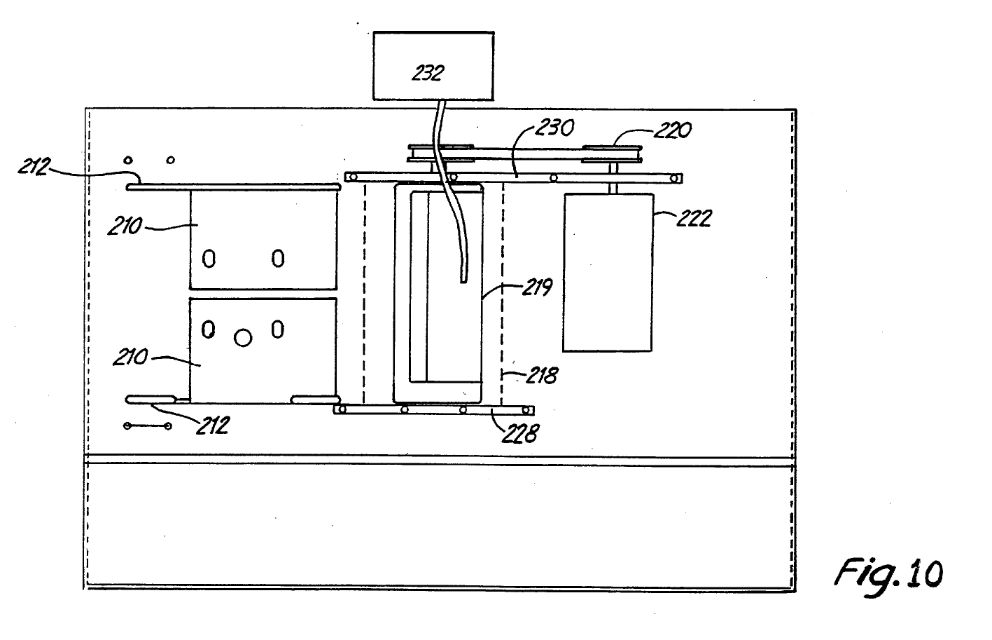

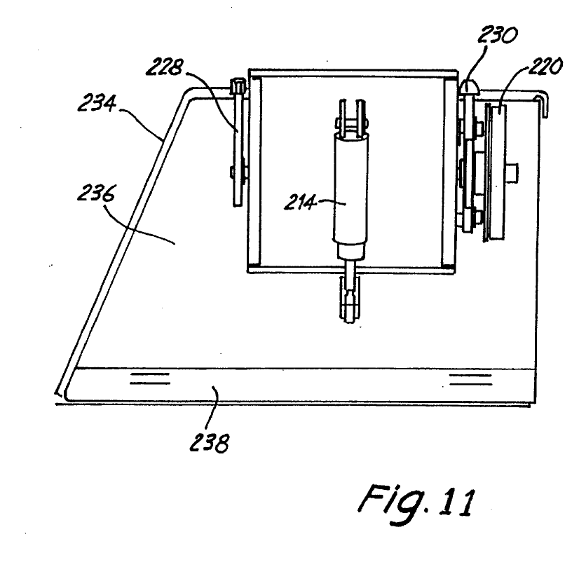

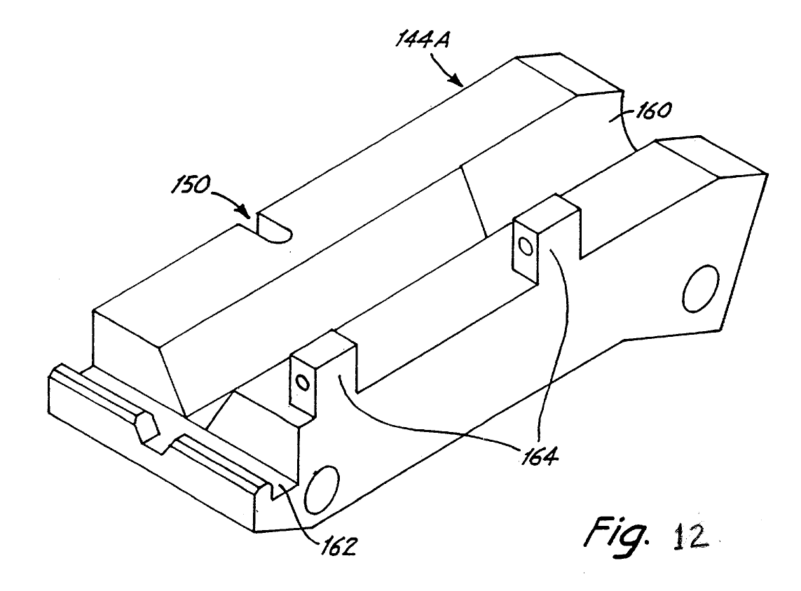

FIG. 10 illustrates a top view of the proofer cleaning apparatus 200 that includes unibody 210 that pivots around pivot points 212. Scrubbing roller 218 is partially shown in visible lines as part of it protrudes through a roller window 219, which pierces the top plate of proofer apparatus 200. Scrubbing roller 218 is supported by roller support bracket 228 and roller and motor support bracket 230. Motor 222 drives pulley drive 220, which in turn drives scrubbing roller 218 thereby spreading cleaning fluid across the surface of scrubbing roller 218. In this example embodiment, a cleaning fluid tank 232 with a fluid tube can be adapted to provide a continuous supply of cleaning fluid to the proofer cartridge disposed above scrubbing roller 218. FIG. 11 illustrates a side view of proofer apparatus 200 including pulley drive 220 and brackets 228 and 230.

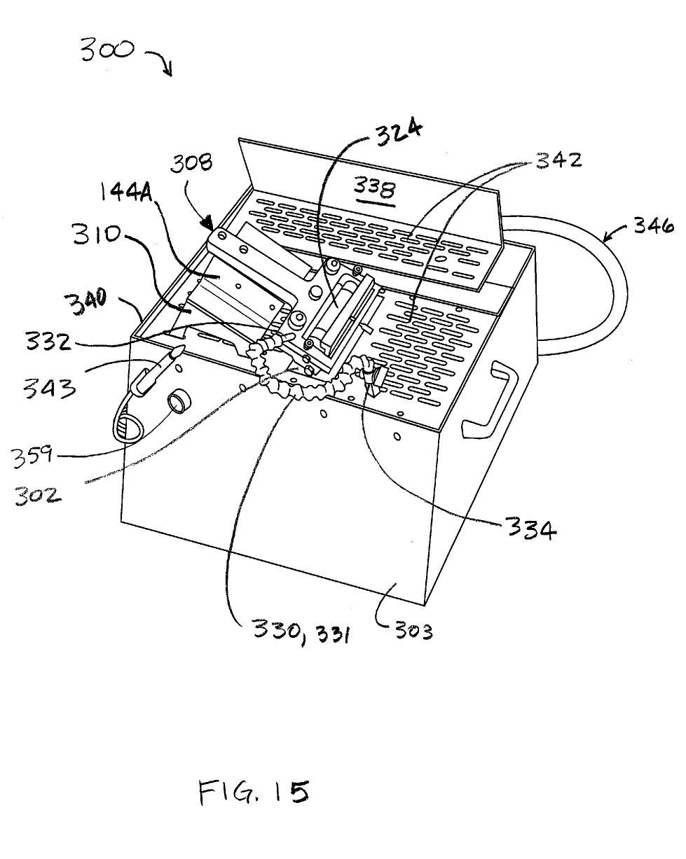

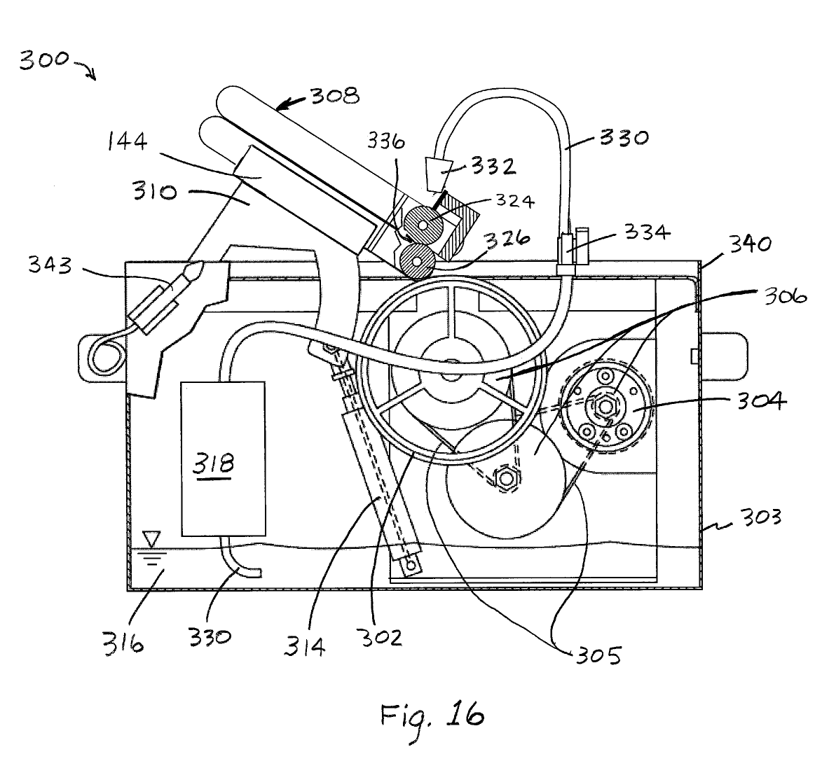

Referring to FIGS. 15 and 16, another embodiment of an ink proofer cleaning apparatus 300 is depicted in perspective and elevation view, respectively. Like the preceding embodiments 100 and 200, the ink proofer cleaning apparatus 300 includes a drum roller 302 inside a housing 303 that is driven by a motor 304 through a series of belts 305 and pulleys 306, and a proofing head 308 that is mounted to a pivoting unibody frame 310 with the universal holder 144A, the unibody frame 310 being is actuated by an actuation/pressure cylinder 314 to retractably engage the proofing head 308 with the drum roller 302. The ink proofer cleaning apparatus 300 does not include a fluid tank inside the housing. Rather, the housing 303 is designed to contain a cleaning solution 316. Accordingly, all of the components within the housing 303 are either compatible with the cleaning solution 316, or are shrouded from its adverse effects.

The ink proofer cleaning apparatus 300 includes a pump 318 that effuses the cleaning solution 316 through a supply line 330 and a jetting nozzle 332. A portion of the supply line 330 near the jetting nozzle 332 may comprise an adjustable structural tubing 331, such as the accordion-folded pleated structure depicted in FIG. 15. The adjustable structural tubing 331 will substantially retain a given shape after being adjusted. A valve 334 may be located in the supply line 330. The ink proofer cleaning apparatus 300 also includes a splashguard 338 and a raised edge 340 that extends above a perforated upper surface 342. An air nozzle 343 connected to a pressurized gas source (not depicted) may be made available.

The jetting nozzle 332 is oriented above the proofing head 308 to direct the exiting cleaning solution 316 onto the anilox roller 324 and the doctor blade 322, or onto a nip region 336 between the anilox roller 324 and the transfer roller 326. The adjustable structural tubing 331 may be configured so that the jetting nozzle 332 floods the rotating members 324, 326 of the proofing head 308 at an oblique angle, as depicted in FIG. 15. After coursing over the rollers 324 and 326, the cleaning solution 316 wets the drum roller 302, with the excess cleaning solution 316 gathering at the bottom of the housing 303.

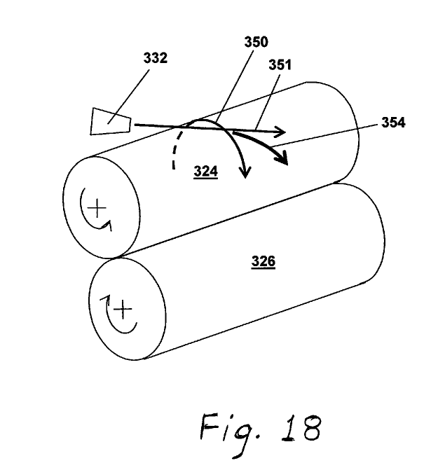

Referring to FIG. 18, the rotation of the anilox roller 324 causes a slip flow 350 between the cleaning solution and the anilox roller 324 in a circumferential direction that is effectively opposite the direction of rotation of the anilox roller 324. The pressurized oblique flow 351 introduced by the jet nozzle 332 provides kinetic energy and creates a cross flow 354 over the surface of the anilox roller 324 that provides a mechanical advantage over and above the soluble cleaning effect of the cleaning solution 316. We have found that by flooding anilox roller 324 with an oblique angle jet spray as depicted, the concentration of the cleaning solution may be reduced by as much as an order of magnitude and still have the same cleaning effect as soaking the anilox roller 324 at full concentration.

A reduced concentration in the cleaning solution 316 reduces costs in two ways. First, a diluted mixture requires the purchase of less cleaning solution up front; and second, the diluted mixture contains fewer volatile organic compounds (VOCs) to deal with in the waste stream, thereby reducing disposal costs.

The splashguard 338 serves to capture over sprays from the jetting nozzle 332 and deflected sprays off the proofing head 308. The raised edge captures runoff that courses over the perforated surfaces 342. The valve 334 is used to temporarily halt flow of the cleaning solution 316 through the jetting nozzle 332 during placement of the proofing head 308 or adjustment of the jetting nozzle.

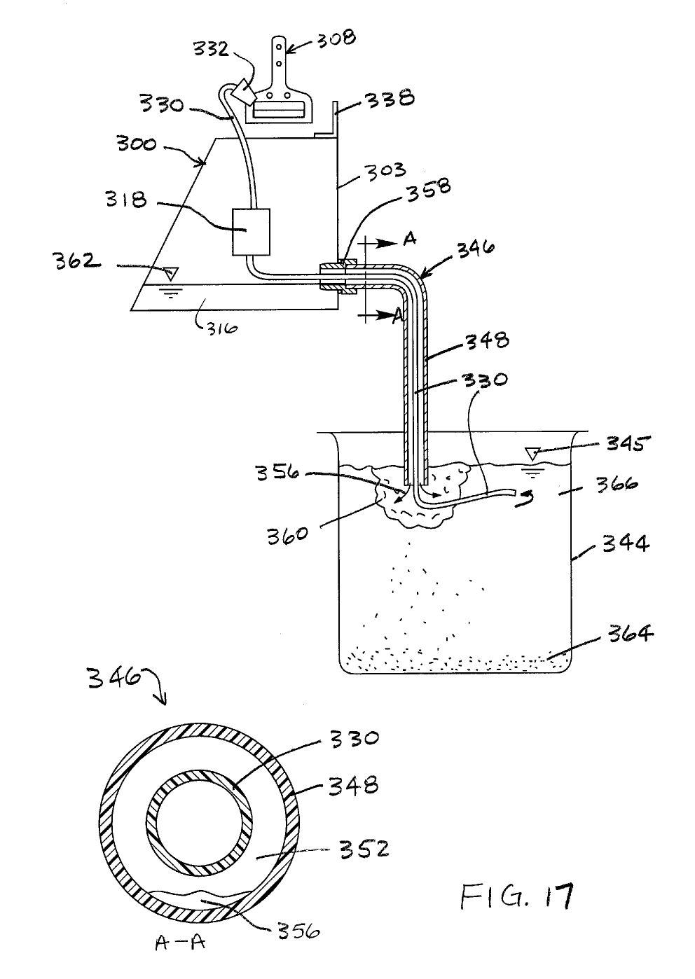

The pump 318 may be configured to draw and re-circulate the cleaning solution 316 from the bottom of the housing 303, as illustrated in FIG. 16. Referring to FIG. 17, an alternative arrangement is illustrated wherein the ink proofer cleaning apparatus 300 draws the cleaning solution 316 from a decantation tank 344 holding the cleaning solution 316 at a level 345. The configuration of FIG. 17 also portrays a unique combination supply/return line 346, wherein the supply line 330 is located inside a return line 348 to create an annular return passage 352 through which ink-laden cleaning solution 356 is routed to the decantation tank 344.

In FIG. 17, the combination supply/return line 346 is routed through a connector 358 on a wall of the housing 303 and through the top of the decantation tank 344. Alternatively, the connector could penetrate the bottom of the housing 303 (not depicted) or a drain pan could be located inside the housing 303 (not depicted), thereby directing the accumulated cleaning solution 316 to the return passage 352. Within the decantation tank 344, the supply line 330 extends beyond the termination of the return line 348 and is routed to one side, away from a return zone 360 where ink-laden cleaning solution 358 returns.

The vertical location of the connector 358 establishes a fluid level 362 in the housing 303. The cleaning solution 316 accumulates in the housing 303 until it reaches the height of the connector, whereupon it the ink-laden cleaning solution 356 drains into the annular return passage 353 and into the decantation tank 344. Preferably, the connector 358 is a swivel or elbow type connector, enabling the ink proofer cleaning apparatus 300 to be positioned close to a wall without crimping the combination supply/return line 346.

Operation of the ink proofer cleaning apparatus 300 is commenced by depressing a single push button starter 359 that initiates a cleaning sequence. The cleaning sequence includes starting the motor 304 to rotate the drum roller 302, driving the actuator 314 to rotate the unibody frame 310 so that the transfer roller 326 of the proofing head 308 is brought into contact with the drum roller 302, and running the pump 318 for a pre-set period of time so as to flood the nip region 336 with the cleaning solution 316. After the flooding operation is complete, the drum roller continues to run for a time before being shut off, followed by reversal of the actuator 314 to remove the proofing head 308 from contact with the drum roller. The air nozzle 343 may be used to blow excess cleaning solution 316 from the proofing head 308, thereby expediting the drying process.

Functionally, the ink residue that is removed from the proofing head 308 will generally remain suspended in the cleaning solution for a period of time, thereby enabling a large percentage of the removed ink to be returned to the decantation tank 344. The alternative non-depicted arrangements of a bottom connector or drain pan structure would return a larger fraction of the ink residue to the decantation tank 344. Eventually, the ink residue that is returned to the decantation tank 344 will settle out of the cleaning solution 316 to the bottom of the decantation tank 344, creating a concentration 364 of ink residue at the bottom of the decantation tank 344. Hence, an upper strata 366 of the cleaning solution 316 in the decantation tank 344 will have only trace amounts of ink residue. By terminating the supply line 330 at a location removed from the return zone 360, but still near the top of the fluid level 345 within the decantation tank 344, contamination of the cleaning solution 316 that is re-circulated through the supply line 330 is further reduced. The decantation arrangement effectively cleanses the cleaning fluid 316, enabling it to be reused, thereby reducing operational and disposal costs.

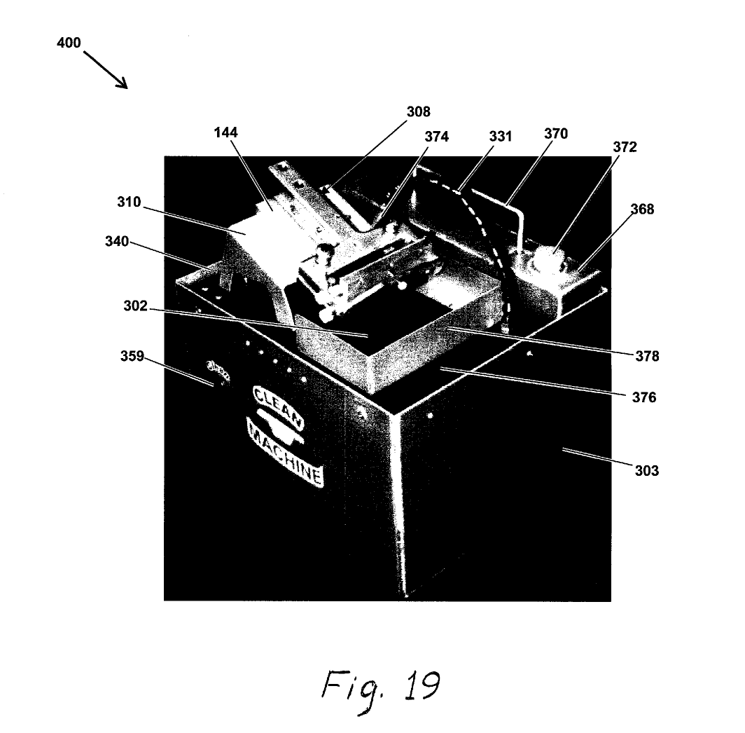

Referring to FIG. 19 another embodiment of an ink proofer cleaning apparatus 400 is presented that includes an inboard container 368 for holding cleaning fluid. The inboard container 368 includes a handle 370 and an access port 372. The cleaning fluid is drawn from the inboard container 368 through access port 372 through a supply line (not depicted), through the adjustable structural tubing 331, and through a diverging nozzle 374. The drum roller 302 protrudes through an upper surface 376 of the housing 303, the upper surface 376 being bordered on all sides by the raised edge 340. A splash guard 378 surrounds the protruding portion of the drum roller 302 on three sides.

In operation, the cleaning fluid in the configuration of FIG. 19 floods the rotating components of the ink proofing head 308 in a substantially vertical fashion and flows over the drum roller 302 before settling in the bottom of the housing 303. The splash guard 376 is brought in closer to the drum roller because of the general downward direction of the flow. Any fluid escaping the splash guard 376 is prevented from flowing over the sides of the housing 303 by the raised edge 340. Once the inboard container 368 is depleted of cleaning fluid, it may be refilled or discarded. The vitiated fluid collecting within the housing may be drained and re-used after decantation or discarded.

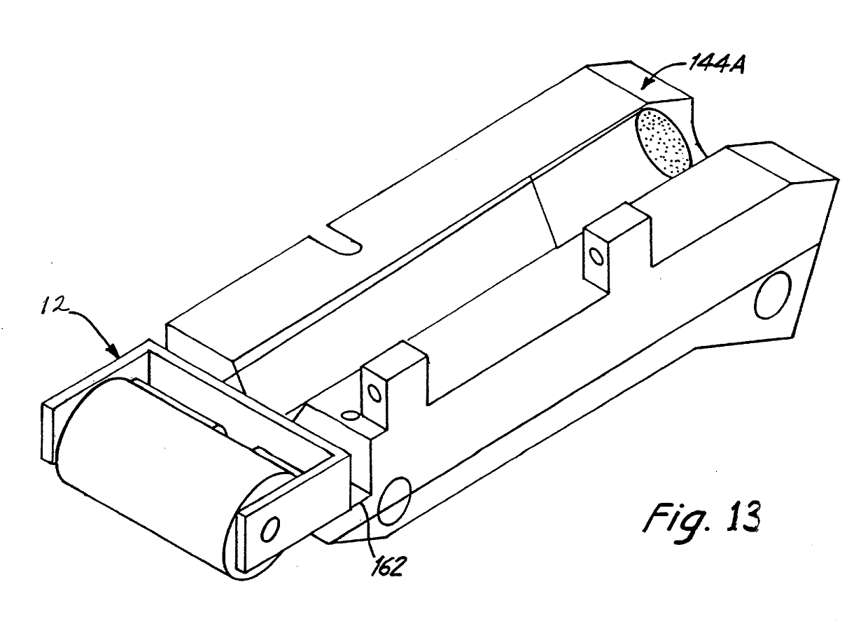

The foregoing ink proofer cleaning apparatuses 100, 200, 300 or 400 can also be used to clean a manually operated hand ink proofer tool. The universal ink proofer holder is modified to hold a hand ink proofer tool instead of an ink proofer cartridge. FIG. 12 illustrates the universal ink proofer holder 144A without ink proofer cartridge 101 and modified to hold a hand ink proofer tool 12 that includes a handle. Universal proofer holder 144A includes a channel 160, which accommodates the handle of a manually operated ink proofer, and a notch 162 that aids in maintaining the ink proofer in universal proofer holder 144A. FIG. 13 illustrates a view of universal ink proofer holder 144A which includes notch 162 and a hand ink proofer tool 12 set in the universal ink proofer holder 144A, with the handle of a manual ink proofer in channel 160. In this embodiment, universal holder 144A is made from a polymer (i.e., plastic) but can also be made from metal or any other material that can be formed to include a channel 160 and notch 162. Channel 160, in this example embodiment, is formed in a V-shaped groove; however, it can be formed in a square groove or circular groove depending on the proofer handle configuration. This example embodiment of cover plate 148 further includes an adjustment knob 168 for adding downward pressure to an ink proofer handle located in channel 160 to secure the proofer holder in the channel 160. Adjustment knob 168 provides the advantage of allowing universal holder 144A to accommodate proofer handles of various diameters while still allowing some angular movement of the proofer handle.

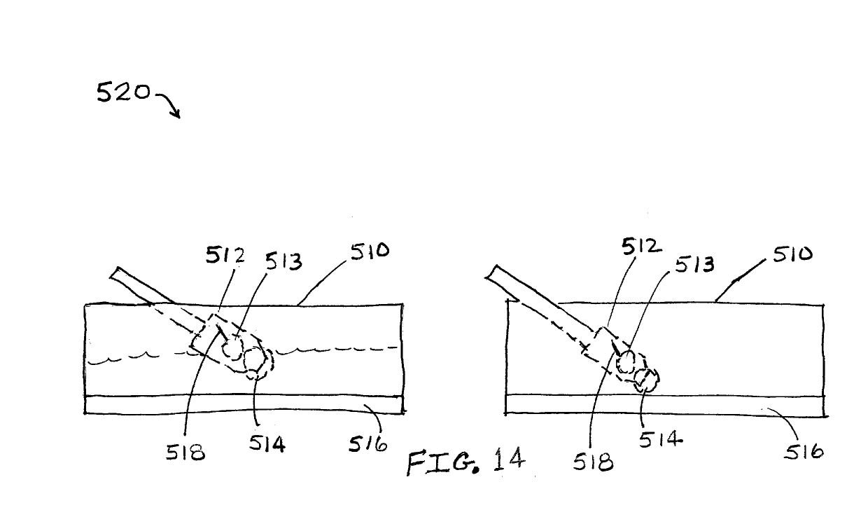

In another example embodiment of the invention, illustrated in FIG. 14, a hand ink proofer cleaning system 520 includes at least two trays 510. Each tray is large enough to contain the hand ink proofer 512, that is, the tray is wide enough to accommodate the width of the anilox roller 513 and the width of the transfer roller 514. Further, tray 510 is deep enough such that transfer roller 514 is positioned at least partially below the lip of tray 510. In addition, tray 510 is long enough such that hand ink proofer 512 can be rolled at least once in tray 510. Each of the trays 510 also contains a rough tray bottom 516 or a rubber pad in the bottom of tray 510. The rubber pad or rough bottom 516 provides a non-slip surface to transfer roller 514, such that transfer roller 514 actually rolls along the bottom of tray 510 instead of slipping along the bottom of tray 510.

The first tray 510 of ink proofer cleaning system 520 contains an ink cleaning solvent or solution. Typically, the solvent is a water-based cleaning solvent. The technician holds the hand ink proofer 512 in first tray 510. Transfer roller 514 is at least partially submerged in the cleaning solvent. The technician holds hand ink proofer 512 and rolls it at least once along the bottom of tray 510. The cleaning solvent wets transfer roller 514 and dislodges any ink that is to be cleaned off the transfer roller 514. The cleaning solvent is drawn from transfer roller 514 to anilox roller 513 and the ink on anilox roller 513 becomes dislodged. The rolling action of transfer roller 514 and anilox roller 513 draws more cleaning solvent to doctor blade 518, to dislodge ink remaining on doctor blade 518. Hand ink proofer 512 may be allowed to remain stationary in the tray 510, to allow hand ink proofer 512 to soak to remove any remaining ink, dependent on, for example, how soon hand ink proofer 512 is needed and how deep the cleaning solvent is/how much of hand ink proofer 512 is submerged in the cleaning solvent.

The technician continues to roll hand ink proofer 512 along the bottom of tray 510 and/or allows hand ink proofer 512 to soak in the cleaning solvent. This combination is used to dislodge ink remaining on transfer roller 514, anilox roller 513, and doctor blade 518, as well as any other parts of hand ink proofer 512 in contact with the cleaning fluid.

Once hand ink proofer 512 is cleaned, hand ink proofer 512 is transferred to a second cleaning tray 510. Second cleaning tray 510 desirably contains a water-alcohol solution. Typically, the alcohol used in the water-alcohol rinse solution is isopropyl alcohol, but other alcohols may be used. The water-alcohol solution is used, for example, to rinse hand ink proofer 512 and to remove remaining ink and cleaning solvent. Here too, the technician may allow hand ink proofer 512 to soak in the rinse solution. The technician also rolls hand ink proofer 512 along the bottom of tray 510 such that the rinse solution is transferred onto transfer roller 514. Continued rolling of hand ink proofer 512 draws rinse solution from transfer roller 514 to anilox roller 513, and from anilox roller 513 to doctor blade 518. The technician determines when the various components of hand ink proofer 512 are sufficiently cleaned and rinsed to be removed from the rinse solution.

The cleaned hand ink proofer 512 is removed from the second tray 510 and inspected for cleanliness. If needed, the cleaning and/or rinsing process may be repeated. Upon determining that hand ink proofer 512 is sufficiently clean, the technician applies a stream of pressurized air to the various parts of the hand ink proofer 512. The pressurized air tends to remove any remaining traces of solvent or solution. As a result, a thoroughly dried hand ink proofer 512 tends to inhibit the formation of any rust or corrosion. Rust or corrosion formation may negatively affect the performance of hand ink proofer 512 and it is therefore desirable to limit its formation.

In another embodiment of the hand ink proofer cleaning system 520, the cleaning process includes the process described above, utilizing a first cleaning tray 510 containing a cleaning solvent and then utilizing a second cleaning tray 510 containing a rinse of a water-alcohol solution. However, in this embodiment of the hand ink proofer cleaning system 520, an additional solution is applied to the hand ink proofer 512. After hand ink proofer 512 has been exposed to the rinse solution in the second tray 510, the hand ink proofer 512 is placed in a third tray 510. The third tray 510 is configured similarly to the first and second trays 510. The third tray 510 may contain alcohol or another volatile solvent, and more particularly, isopropyl alcohol. The hand ink proofer 512 is placed in the alcohol and may be allowed to soak. The transfer roller 514 of the ink hand proofer 512 is at least partially submerged in the alcohol. The technician rolls ink hand proofer 512 along the bottom of the tray 510, such that the transfer roller 514 draws up the alcohol and transfers the alcohol to anilox roller 513 and doctor blade 518. Continued rolling of the transfer roller 514 along the bottom of the tray 510 provides alcohol to the anilox roller 513 and to the doctor blade 518. Dependent upon the depth of the alcohol in the third tray 510, other parts of the ink hand proofer 512 are also exposed to the alcohol.

The alcohol assists in drying the hand ink proofer 512 by wicking away water from the various surfaces of the hand ink proofer 512. The removal of water assists in preventing corrosion formation on the hand ink proofer 512. Once the hand ink proofer 512 is removed from the third tray 510, the hand ink proofer 512 may be exposed to a stream of pressurized air to aid in drying the hand ink proofer 512.

Although a two or three tray 510 cleaning system is described above, those skilled in the art will understand that variations of the cleaning system are contemplated and are included in the scope of the disclosed invention. These variations may include a single tray cleaning system as well as four or more cleaning tray systems.

Examples of ink proofer tools that can be used with the present invention include those described in U.S. patent application Ser. No. 11/382,381, hereby incorporated by reference in its entirety, and U.S. patent application Ser. No. 11/382,435, also hereby incorporated by reference in its entirety.

The various embodiments of the present invention provide ink proofer cleaning arrangements, primarily directed to cleaning hand ink proofers and ink proof cartridges. The present invention may be embodied in other specific forms without departing from the essential attributes thereof, therefore, the illustrated embodiments should be considered in all respects as illustrative and not restrictive.

We claim:

1. An ink proofer cleaning apparatus, comprising:
a base unit including a continuous movable surface and a support structure both operably attached to said base unit;
a hand held ink proofing head detachably secured to said support structure, said ink proofing head comprising a transfer roller and an anilox roller,
said support structure being positionable to cause said proofing head to contact said continuous movable surface;
a wetting means for causing a cleaning fluid to contact said continuous movable surface or said ink proofing head;
such that, when said proofing head is in contact with said continuous movable surface, movement of said continuous movable surface causes rotation of said transfer roller and said anilox roller and causes said cleaning fluid to be transferred amongst said continuous movable surface, said transfer roller and said anilox roller to substantially clean said anilox roller.

2. The ink proofer cleaning apparatus of claim 1 wherein said continuous movable surface is a drum roller.

3. The ink proofer cleaning apparatus of claim 1 wherein said ink proofing head further comprises a doctor blade.

4. The ink proofer cleaning apparatus of claim 1 wherein said ink proofing head is a manual ink proofer.

5. The ink proofer cleaning apparatus of claim 1 wherein said wetting means comprises a pump that effuses said cleaning fluid through a fluid supply line and onto said proofing head.

6. The ink proofer cleaning apparatus of claim 5 further comprising a decantation tank and a fluid return line, wherein said cleaning fluid is drawn from said decantation tank through said fluid supply line and returned to said decantation tank through said fluid return line.

7. The ink proofer cleaning apparatus of claim 6 wherein at least a portion of said fluid supply line is coaxial with said fluid return line.

8. A method for cleaning an ink proofer, comprising:
selecting an ink proofer comprising a transfer roller and an anilox roller;
selecting an ink proofer cleaning apparatus comprising a support structure, a movable continuous surface, and a wetting means for causing said continuous surface to be wetted with a cleaning solution;
operably connecting said ink proofer to said support structure of said in proofer cleaning apparatus;
placing at least one of said transfer roller and said anilox roller in contact with said continuous surface; and
causing said continuous surface to move, thereby causing at least one of said transfer roller and said anilox roller to rotate and said cleaning solution to be transferred amongst said continuous surface and at least one of said transfer roller and said continuous surface.

9. The method of claim 8 for cleaning an ink proofer further comprising:
energizing said wetting means to cause cleaning solution to course over said transfer roller, said anilox roller and said continuous surface.

10. The method of claim 8 further comprising:
applying a force to said ink proofer to cause a drag force on one of said anilox roller and said transfer roller, thereby causing at least one of said anilox roller and said transfer roller to slip relative to said continuous surface, so that a scrubbing action is caused between said continuous surface and at least one of said anilox roller and said transfer roller.

11. A system for cleaning an ink proofer tool, said ink proofer tool including an anilox roller that can be brought into contact with a transfer roller, said system comprising:
an endless movable surface;
means for supporting said ink proofing tool, said means for supporting said ink proofing tool being operably shiftable between a first position where neither of said anilox roller and said transfer roller is in contact with said endless movable surface and a second position where said one of said anilox roller and said transfer roller is in contact with said endless movable surface;
means for containing a supply of cleaning fluid;
means for delivering a substantially continuous flow of said cleaning fluid from said container to a vicinity of said anilox roller, said transfer roller and said endless movable surface.

12. The system as claimed in claim 11, further comprising means for returning fluid to said container.

13. The system as claimed in claim 12, wherein said means for containing said cleaning fluid is housed separately from said endless movable surface and said means for containing said cleaning fluid is in fluid communication therewith via a fluid conduit having a first tubular structure and a second tubular structure, said second tubular structure being located within said first tubular structure.

14. The system as claimed in claim 11, wherein said means for delivery delivers cleaning fluid directed toward said anilox roller or said transfer roller.

15. The system as claimed in claim 11, wherein said means for delivery delivers cleaning fluid directly onto said endless movable surface.

16. A method for cleaning an ink proofer tool, said ink proofer tool including an anilox roller that can be brought into contact with a transfer roller, said method comprising:
moving an endless surface;
supporting said ink proofing tool near said endless surface;
operably shifting said ink proofing tool between a first position where neither of said anilox roller and said transfer roller is in contact with said endless surface and a second position where said one of said anilox roller and said transfer roller is in contact with said endless surface;
supplying cleaning fluid in a container;
delivering a substantially continuous flow of said cleaning fluid from said container to a vicinity of said anilox roller, said transfer roller and said endless surface.

17. The method as claimed in claim 16, further comprising returning fluid to said container from said vicinity of said anilox roller, said transfer roller and said endless surface.

18. The method as claimed in claim 17, further comprising:
containing said cleaning fluid at a remote location from said vicinity of said endless surface; and
transporting said cleaning fluid between said remote location and said vicinity of said endless surface via a fluid conduit having a first tubular structure and a second tubular structure, said second tubular structure being located within said first tubular structure.

19. The system as claimed in claim 11, further comprising delivering said cleaning fluid such that said cleaning fluid is directed toward said anilox roller or said transfer roller.

20. The system as claimed in claim 11, further comprising delivering said cleaning fluid such that said cleaning fluid is directed toward said endless surface.
